(19) United States
(12) Patent Application Publication
(10) Pub. No.: US 2014/0271994 A1
(43) Pub. Date: Sep. 18, 2014

(54) MEAT SLURRY CULTURE

(71) Applicants: Richard Baird Smittle, Morgantown, OH (US); John Boyd Phelps, Andover, NJ (US)

(72) Inventors: Richard Baird Smittle, Morgantown, OH (US); John Boyd Phelps, Andover, NJ (US)

(21) Appl. No.: 13/838,314

(22) Filed: Mar. 15, 2013

(51) Int. Cl. A23K 1/10

(52) U.S. Cl. CPC A23K 1/10
USPC 426/63; 426/61

(57) ABSTRACT

A meat slurry composition with extended shelf-life and incorporated into pet food. The extended shelf-life of the meat slurry occurs due to the making of a cultured meat slurry. The cultured meat slurry includes a meat slurry, a culture energy source and a starter culture. The cultured meat slurry may also contain the addition of proteolytic enzymes. The cultured meat slurry may also be vacuum packaged. The method of forming the cultured meat slurry is also described.

### BACKGROUND

The present disclosure relates generally to food ingredients. More specifically the present disclosure relates to making meat-based ingredients have a longer shelf-life until inclusion within or on a pet food product.

Pet food is typically made up of several different ingredients including meat. It is most economical to obtain meat scraps which would otherwise be considered waste. The current practice within the pet food industry in handling the meat scraps entails collecting the meat scraps from the slaughtering process then freezing these meat scraps. Due to concerns with product spoilage, the meat scraps must be used within 5 days post slaughtering. While this practice is feasible by using refrigeration transport trucks and a refrigeration supply chain, it is costly and places significant pressure on manufacturers to use all frozen meats within such a short period of time. In addition, current guidance by the FDA advises frozen transport of meats used in pet foods. As such, persons working in the meat ingredient supply industry have become accustomed to a long standing practice of freezing meat during transport to pet food manufacturing plants.

Regarding the manufacture of a complete pet food, there are a number of ways this is currently accomplished. The most common commercial manufacturing technique involves extruding the meal into a complete formed kibble. This technique has a number of benefits such as being relatively shelf-stable and avoiding the transport of a lot of water since it is typically a dry food (less than ten percent moisture). Another common commercial manufacturing technique involves retorting the food into a small, typically single-serve, package. This technique is regarded as one of the most palatable pet food product forms. As cats are susceptible to the formation of kidney/urinary stones, the other benefit to cats is that it helps assure a certain minimum amount of water consumption that is important for reducing the likelihood of stone formation. While other product formats exist that could provide a complete pet food such as baked biscuits, semi moist (20 to 40% moisture) and chubb formats (40% moisture), these formats are typically regarded by consumers as “supplemental” formats and are not intended to replace the required nutrition for one's pet. Regardless, all of these product formats require a heating step to deactivate pathogenic and(or) spoilage microorganisms typically associated with meats. Some examples of pathogenic microorganisms include Salmonella, pathogenic E. coli, and Clostridia.

One example of making such a pet food product is contained within U.S. Pat. No. 4,041,181. This disclosure is herein incorporated by reference. This patent describes the making of a pet food product that contains fermented and autolyzed proteinaceous material, usually some form of animal tissue, that is bound by a gelled binder and stabilized against microbiological activity by an acid pH. The product has an antimycotic added to it and the product is then shaped by extrusion and cooked.

While U.S. Pat. No. 4,041,181 involves the addition of microbes to meat, it is a finished pet food product and requires that the product be shaped and heated (cooked within an extruder). It further indicates that a binder be added to create a texture that is chewy in nature and a humectant to control water activity of the product. The problem with this approach is that the meat is cooked with an extruder and other additives such as the binder and humectant transform the meat into a finished product. This requires much energy expenditure and does not solve the question of how to extend the shelf-life of the meat slurry ingredient before it is used in a pet food finished product.

Accordingly, there is a continuing unmet need to extend the shelf-life of meat slurry ingredients used in the production of finished pet food products.

### SUMMARY OF THE INVENTION

The present disclosure relates to a pet food ingredient that is a meat slurry having been cultured to deactivate the pathogenic and certain spoilage organisms in the meat. In one embodiment, this cultured meat slurry has an improved shelf-life that enables at least ten days of shelf-life before the meat slurry must be used in the production of pet food.

In another embodiment, the composition and process to form a cultured meat slurry involves the addition of a starter culture and a culture energy source to one or more meats. The mixture is then cultured for eight hours at a temperature between 100 and 110° F. The resulting cultured meat slurry has an improved shelf-life that enables at least 10 days of shelf-life before the meat slurry must be used in the production of pet food. A non-limiting embodiment of the source of meat is chicken. A non-limiting embodiment of the source of starter culture is Pediococcus acidilactici and Pediococcus pentosaceus. A non-limiting embodiment of the source of culture energy source is dextrose.

In yet another embodiment, the composition and process to form a cultured meat slurry involves the addition of a starter culture and a culture energy source to one or more meats. The mixture is then stored under vacuum for eight hours at a temperature between 100 and 110° F. The resulting meat slurry has an improved shelf-life that allows at least 10 days before the meat slurry must be used in the production of pet food.

In still yet another embodiment, the composition and process to form a cultured meat slurry involves the addition of a starter culture and apple juice concentrate to a meat source. The mixture is then cultured for eight hours at a temperature between 100 and 110° F. The mixture is cultured for at least one additional hour at a temperature between 120 and 130° F. The resulting meat slurry has an improved shelf-life that allows at least 10 days before the meat slurry must be used in the production of pet food.

In still yet another embodiment, the composition and process to form a cultured meat slurry involves the addition of a starter culture, a culture energy source, and proteolytic enzymes to one or more meats. The mixture is then cultured for at least eight hours at a temperature between 100 and 110° F. The resulting meat slurry has an improved shelf-life that allows at least 10 days before the meat slurry must be used in the production of pet food.

### BRIEF DESCRIPTION OF THE FIGURES

FIG. 1 shows a graph depicting the change in bacterial counts and pH over time of a cultured beef meat slurry. The fate over time of the Enterobacter aerogenes ATCC 13048 and Escherichia coli ATCC 8739 coliforms which are surrogates for Salmonella and Escherichia coli O157:H7, respectively, is depicted by the dashed line. Meanwhile, changes in lowering the pH over time are depicted by the solid line. The lowered pH occurs due to the production of acids from the starter cultures, Pediococcus acidolactici and Pentosaceus, utilizing the culture energy source.

FIG. 2 shows a graph depicting the change in bacterial counts and pH over time of a cultured pork meat slurry. The fate over time of the Enterobacter aerogenes ATCC 13048 and Escherichia coli ATCC 8739 coliforms which are surrogates for Salmonella and Escherichia coli O157:H7, respectively, is depicted by the solid line. Meanwhile, changes in lowering the pH over time are depicted by the dashed line. The lowered pH occurs due to the production of acids from the starter cultures, Pediococcus acidolactici and Pentosaceus, utilizing the culture energy source.

### DETAILED DESCRIPTION OF THE INVENTION

### Definitions

As used herein, the articles including “the”, “a” and “an” when used in a claim or in the specification, are understood to mean one or more of what is claimed or described.

As used herein, the terms “include”, “includes” and “including” are meant to be non-limiting.

As used herein, the term “animal” and “pet” means a domestic animal including, but not limited to domestic dogs, cats, horses, cows, ferrets, rabbits, pigs and the like. Domestic dogs and cats are particular examples of pets.

As used herein, the terms “animal feed”, “animal feed compositions”, animal feed kibble”, “pet food” or “pet food composition” mean a composition intended for ingestion by a pet. Pet foods may include, without limitation, nutritionally balanced compositions suitable for daily feed, as well as supplements (e.g., treats) which may or may not be nutritionally balanced.

As used herein, the term “starter culture” means a composition of bacteria that can serve in a beneficial role of promoting competitive exclusion of otherwise pathogenic bacteria inherent within a meat source. The starter culture will also lower the meat slurry pH that will prevent further growth of bacteria.

As used herein, the term “culture energy source” means a composition of fermentable carbohydrates in a liquid composition and serves a beneficial role of providing a carbohydrate energy source to aid the starter culture in beginning its growth in the meat slurry.

As used herein, the term “proteases” means one or more proteolytic enzymes that are capable of breaking amino acid bonds within meat protein.

As used herein, the term “meat slurry” means a composition comprising meat obtained from a slaughterhouse and intended for pet food use only and has been ground up into a flow-able, particulate material. A meat slurry is commonly used as an ingredient in pet food.

As used herein, the term “cultured meat slurry” means a composition consisting of a meat, a culture energy source, and a starter culture. The combination has been allowed to incubate to enable the starter culture to grow. Growth of bacteria in the meat slurry enables the mixture to be called a cultured meat slurry. Various additional components such as proteases may be added.

All percentages and ratios are calculated and provided by weight unless otherwise indicated. All percentages and ratios are calculated and provided based on the total composition unless otherwise indicated.

Referenced herein may be trade names for components including various ingredients utilized in the present disclosure. The inventors herein do not intend to be limited by materials under any particular trade name. Equivalent materials (e.g., those obtained from a different source under a different name or reference number) to those referenced by trade name may be substituted and utilized in the descriptions herein.

In the description of the various embodiments of the present disclosure, various embodiments or individual features are disclosed. As will be apparent to the ordinarily skilled practitioner, all combinations of such embodiments and features are possible and can result in preferred executions of the present disclosure. While various embodiments and individual features of the present invention have been illustrated and described, various other changes and modifications can be made without departing from the spirit and scope of the invention. As will also be apparent, all combinations of the embodiments and features taught in the foregoing disclosure are possible and can result in preferred executions of the invention.

Various non-limiting embodiments of the present disclosure include a cultured meat slurry comprising a meat source and a starter culture. Other embodiments include a cultured meat slurry comprising a meat source, a starter culture, and a culture energy source. Yet other embodiments include a cultured meat slurry comprising a meat source, a starter culture, a culture energy source and proteases. Still other embodiments include methods of forming the meat slurry culture composition disclosed herein.

Various embodiments of the present disclosure may further provide for a cultured meat slurry where the sources of meat that could be formed into a meat slurry consists of the following: chicken, turkey, beef, lamb, venison, buffalo, pork and the like. The meat is typically obtained during the slaughtering process of animals. While the main parts of the animal are obtained typically from skeletal muscle and packaged for sale as human food, less desirable components of the animal such as internal organs (heart, liver, thymus, kidneys and the like) along with meat trimmings from the residual parts of the skeletal muscle is either placed in a mechanical device that separates the trimmings from the bone or ground up and heated to separate the pieces of protein from the fat. Since meat typically contains about 70% moisture, these meat trimmings and internal organs can be ground up and emulsified to form a meat slurry. One embodiment of how the meat is ground up involves a two stage process involving coarse grinding followed by fine grinding. The coarse grinding may be carried out via a continuous meat grinder, such as those manufactured by Weiler & Company or Wolfking & Company. In one embodiment of coarse grinding the feed screw may be selected from standard types for frozen or fresh materials, depending on what meat source is used. In one embodiment the holeplate hole sizes are between three mm and ten mm. The fine grinding, or emulsification, is performed by a standard meat slurry emulsification unit, for example those machines manufactured by Karl Schnell or Wolfking & Company. In one embodiment the holeplate hole sizes are between 1.7 mm and 6.0 mm. In one embodiment the output temperature from the fine grinding unit operation should not exceed 77 to 95° F. This meat slurry makes a very useful ingredient within the pet food industry.

In current practice once the meat slurry is obtained, it is refrigerated to assure it does not rapidly decompose. The meat slurry is shipped to a manufacturer of pet foods. The meat slurry is processed into a finished product pet food. The time from which the slaughtering process occurs until the making of the complete pet food typically exceeds no more than five days. The reason for this relatively short period of time is that the meat slurry is susceptible to enzyme and microbial degradation.

Various embodiments of the present disclosure may further provide for extending the shelf life of the meat ingredient for more than five days up to at least ten days. Other embodiments of the present disclosure may provide for extending the shelf life of the meat ingredient to at least 14 days. Still other embodiments of the present disclosure may provide for extending the shelf life of the meat ingredient to at least 4 months. Yet other embodiments of the present disclosure may provide for extending the shelf life of the meat ingredient to at least 10 months. Storage conditions are understood to be at standard ordinary refrigerated, non-freezing conditions.

Extending the shelf-life of the meat slurry provides the advantage of greater ease and flexibility of handling the meat slurry.

As used herein, the term “shelf life” refers to the length of time that a meat slurry can be maintained at a pH less than 5.0 and not smell of off-odors or decomposing odors. An off or decomposing odor can be demonstrated by allowing an unfermented meat slurry in a container maintained at 95 to 100° F. for at least 8 to 12 hours.

Various embodiments of the present disclosure may further provide for a source of meat obtained from mechanically deboned chicken, mechanically separated chicken, mechanically deboned turkey, mechanically separated turkey, meat and bone meal, and the like.

Various embodiments of the present disclosure may further provide for a cultured meat slurry where the sources of starter culture used comprises at least one bacteria source. As described herein, examples of suitable bacteria sources for use in the various embodiments of the present disclosure include but are not limited to, Pediococcus acidilactici, Pediococcus pentosaceus, Lactococcus lactis, Lactococcus cremoris, Lactobacillus delbruckii var bulgaricus, Lactobacillus plantarum, Lactobacillus pentosum, Streptococcus thermophilus, Lactobacillus sakei and Lactobacillus curvatus. In one specific embodiment, the starter culture may be Pediococcus acidilactici and Pediococcus pentosaceus.

The addition of bacteria through a starter culture is juxtaposed to current industry practice. Current industry practice is to avoid bacterial growth by cooling the meat slurry as quickly as possible and then using the meat slurry in the production of a finished product pet food as quickly as possible so as to have limited bacterial growth and thus limited meat slurry degradation. It is further surprising that using bacteria to control bacterial growth in a meat slurry is possible at a range of storage conditions. While starter cultures are effective at lower temperature levels of maintaining minimal bacterial growth, they are also effective at higher temperature levels at maintaining minimal bacterial growth.

It is recognized that the addition of a starter culture to a meat slurry may produce fermentation by-products such as short-chain fatty acids (acetate, propionate, butyrate), branched chain fatty acids (valerate, isovalerate, isobutyrate), lactic acid and potentially other putrefactive substances (putrescine, cadaverine). While several of these are known to be odiferous compounds that may change the sensory characteristics of the meat, the growth of the starter cultures will help exclude the growth of spoilage bacteria that may cause the quality of the meat to degrade.

An embodiment of the starter cultures may be as a lyophilized culture. A lyophilized culture is bacteria that have been freeze dried and are now in a dormant state. The lyophilized culture is revitalized by adding 1 g of starter culture to 50 g of water (as distilled water or water without free chlorine). Revitalization of the lyophilized culture in water is allowed to occur for at least 15 to 20 minutes at 65 to 75° F. After the culture has been exposed in water for this time it is now resuscitated and able to grow.

In another embodiment the starter cultures may be as a frozen mass until they need to be added to the meat slurry. The frozen starter culture is prepared by harvesting specific bacteria from culturing broth using filtration and/or centrifugation. The harvested cells are then mixed cold with one or more cryoprotectants and frozen for shipment and/or storage. Non-limiting examples of cryoprotectants could include glycerol, dimethyl sulfoxide, DMSO, propylene glycol, sucrose, and the like. Before adding to the meat slurry the frozen starter cultures may be thawed to between 50 and 75° F. and then added to the meat slurry. In still another embodiment the harvested cells can be used without freezing if added to a meat slurry the same day of preparation.

Further embodiments of the present disclosure provide non-limiting dosages of starter cultures could include at least 1×10³ cfu/g, at least 1×10⁴ cfu/g, at least 1×10⁵ cfu/g, at least 1×10⁶ cfu/g, at least 1×10⁷ cfu/g, at least 1×10⁸ cfu/g, at least 1×10⁹ cfu/g, at least 1×10¹⁰ cfu/g of meat. In other embodiments a starter culture may be added to the meat slurry at a dosage of between about 1×10⁷ cfu/g and about 1×10⁸ cfu/g of meat.

Various embodiments of the present disclosure may further provide for a cultured meat slurry where the sources of culture energy source used comprises apple juice, apple juice concentrate, dextrose, dextrose monohydrate, dextrose hydride, grape sugar, D-glucose, corn sugar, corn syrup solids, high fructose corn syrup, levulose, glucose, galactose, xylose, ribose, mannose, sorbose, high fructose corn syrup, apple pulp, honey, sugar, maple syrup, pear juice, grape juice, orange juice, and fruit juice. In one specific embodiment the culture energy source may comprise dextrose. In another embodiment the culture energy source may comprise apple juice concentrate.

An additional step of adding proteolytic enzymes may be used in the production of the cultured meat slurry. Using this step may aid the formation of a less viscous, more liquid-like meat slurry. This provides the additional benefit of the cultured meat slurry being a more flowable, pumpable liquid. A less viscous cultured meat slurry aids in finished product production processes that utilize continuous flow operations where the metering in of the cultured meat slurry is important for consistent application rates.

Various embodiments of the present disclosure may further provide for a cultured meat slurry where the sources of protease used comprises papain, bromelain, ficin, enzymes from Aspergillus oryzae, enymes from Bacillus subtilis var amyloliquifacians, protease from Bacillus licheniformis, pepsin from porcine and chicken stomachs and the like. Other embodiments include commercial sources of meat tenderizer including a source of bromelain which is available from Parchem Fine & Specialty Chemicals located in New Rochelle, N.Y., Nutriteck Bulk Products Division of Ultra Bio-Logics Inc. located in Rigaud, QC Canada or from Lawry's Foods, LLC located in Sparks, Md. as found in as Adolph's® meat tenderizer (a source of bromelain). Still other embodiments include commercial sources of meat tenderizer including a source of papain which is available from Kroger® located in Cincinnati, Ohio as found in Kroger® Meat Tenderizer (a source of papain).

Further embodiments of the present disclosure provide non-limiting dosages that may include papain at least 500 Milk Clot Unit (MCU) per pound of meat, including 1,000 MCU per pound of meat, including 1,500 MCU per pound of meat, including 2,000 MCU per pound of meat, including up to 5,000 MCU per pound of meat which includes 2,000 MCU per pound of meat, which includes 1,500 MCU per pound of meat such as 1,500 MCU per pound of meat, bromelain at least 200 Milk Clot Unit (MCU) per pound of meat, including 1,000 MCU per pound of meat, including 1,400 MCU per pound of meat, including 2,000 MCU per pound of meat, including up to 5,000 MCU per pound of meat which includes 2,000 MCU per pound of meat, which includes 1,400 MCU per pound of meat such as 1,400 MCU per pound of meat, ficin at least 200 Milk Clot Unit (MCU) per pound of meat, including 800 MCU per pound of meat, including 1,240 MCU per pound of meat, including 2,000 MCU per pound of meat, including up to 5,000 MCU per pound of meat which includes 2,000 MCU per pound of meat, which includes 1,240 MCU per pound of meat such as 1,240 MCU per pound of meat, aspergillus at least 1,000 Hemoglobin Unit (HUT) per pound of meat, including 2,000 HUT per pound of meat, including 3,600 HUT per pound of meat, including 5,000 HUT per pound of meat, including up to 10,000 HUT per pound of meat which includes 5,000 HUT per pound of meat, which includes 3,600 HUT per pound of meat such as 3,600 HUT per pound of meat, bacillus at least 100 Proteolytic Unit (PC) per pound of meat, including 300 PC per pound of meat, including 670 PC per pound of meat, including 1,000 PC per pound of meat, including up to 2,000 PC per pound of meat which includes 1,000 PC per pound of meat, which includes 670 PC per pound of meat such as 670 PC per pound of meat. The Milk Clot Unit (MCU) analytical method is as referenced in The Milk-Clotting Action of Papain, A. K. Balls and S. R. Hoover, J. Biol. Chem. 121, 737 (1937) herein incorporated by reference and described by the Enzyme Development Corporation (Internet search performed on Dec. 20, 2012 at http://www.enzymedevelopment.com/wp-content/uploads/2011/10/Milk-Clot-MCU.pdf herein incorporated by reference). The Protease (PC) analytical method is as referenced in Food Chemical Codex, Fourth Edition, Jul. 1, 1996. p. 811-812 herein incorporated by reference and described by the Enzyme Development Corporation (Internet search performed on Dec. 20, 2012 at http://www.enzymedevelopment.com/wp-content/uploads/2011/10/Protease-PC-UNCO.pdf herein incorporated by reference).

Various embodiments of the present disclosure may further provide for methods of forming the cultured meat slurry. According to specific embodiments, the method may comprise obtaining one or meat sources, grinding this meat to form a meat slurry and then adding a starter culture. The meat slurry and starter culture are then heated. The result is that a cultured meat slurry is formed due to the growth of the starter culture in the presence of heat.

Heat is useful to help aid the growth of the starter culture. However, the amount and duration of heat is critical to assuring optimal fermentation occurs.

Another embodiment of the method comprises obtaining one or more meat sources, grinding this meat to form a meat slurry and then adding a starter culture and culture energy source. The meat slurry, starter culture and culture energy source are then heated in two stages. Various embodiments of the first heating stage include a temperature between 100 and 110° F. for 6 to 8 hours, 8 to 10 hours, 10 to 12 hours or 12 to 18 hours in length. Various embodiments of the second heating stage include a temperature between 120 to 130° F. for 40 to 60 minutes, 60 to 90 minutes or 90 to 120 minutes. The result is that a cultured meat slurry is formed due to the growth of the starter culture in the presence of the culture energy source and heat.

Yet another embodiment of the method comprises obtaining one or more meat sources, grinding this meat to form a meat slurry and then adding a starter culture, culture energy source and proteolytic enzymes. The meat slurry, starter culture, culture energy source and proteolytic enzymes are then heated. The result is that a cultured meat slurry is formed due to the growth of the starter culture in the presence of the culture energy source and heat. The proteolytic enzymes may serve to decrease the viscosity of the meat slurry and(or) alter the sensory profile of the meat.

In specific embodiments, the heating of the meat slurry is done with a heat exchanger while other embodiments of heating the meat slurry may be done using a conventional oven, ohmic heating, limited autoclave derived heating, and microwave heating.

While various specific embodiments have been described in detail herein, the present disclosure is intended to cover various different combinations of the disclosed embodiments and is not limited to those specific embodiments described herein. The various embodiments of the present disclosure may be better understood when read in conjunction with the following representative examples. The following representative examples are included for purposes of illustration and not limitation.

### EXAMPLES

### Example 1

### Composition and Method of Making Chicken Meat Slurry Enriched with Starter Culture

In this Example, one embodiment of a cultured meat slurry as would occur in a typical slaughter house facility comprises mechanically deboned chicken mixed with apple juice concentrate that contains a starter culture.

The composition of the cultured meat slurry is set forth in Table 1. The mechanically deboned chicken was ground and emulsified to form a meat slurry. The apple juice concentrate was added into the meat slurry at 5.5% by weight of the total mixture. The starter culture, consisting essentially of Pediococcus acidilactici and Pediococcus pentosaceus (Bactoferm LHP, Chr. Hansen, Milwaukee, Wis.), was added to distilled water (42 g starter culture/100 g water) and the cultures were allowed to rejuvenate for 30 min at ambient (65 to 75° F.) temperature. The starter culture water mixture (142 g/500 pounds of meat slurry) was then dosed at a level sufficient to provide 1×10⁷ cfu of starter culture/g of meat. The mixture of apple juice concentrate, meat slurry and starter culture was brought to a temperature between 104 and 110° F. and then incubated between 8 and 14 hours. The incubated mixture resulted in a pH of about 4.6.

TABLE 1
Meat Slurry Composition

| Ingredient | Percent by Weight |
|---|---|
| Mechanically deboned chicken | To 100 |
| Apple Juice Concentrate | 5.5 |
| Starter Culture* | 0.0626 |

*Starter Culture contains sufficient Pediococcus acidilactici and Pediococcus pentosaceus to provide 1 × 10⁷ cfu/g of mechanically deboned chicken meat.

### Example 2

### Composition and Method of Making Chicken Meat Slurry Enriched with Starter Culture

In this Example, one embodiment of a cultured meat slurry as would occur in a typical slaughter house facility comprises mechanically deboned chicken mixed with dextrose that contains a starter culture.

The composition of the cultured meat slurry is set forth in Table 2. The mechanically deboned chicken was ground and emulsified to form a meat slurry. The dextrose was added into the meat slurry at 2% by weight of the total mixture. The starter culture, consisting essentially of Pediococcus acidilactici and Pediococcus pentosaceus (Bactoferm LHP, Chr. Hansen, Milwaukee, Wis.), was added to distilled water (42 g culture/100 g water) and the cultures were allowed to rejuvenate for 30 min at ambient (65 to 75° F.) temperature. The starter culture water mixture (142 g/500 pounds of meat) was then dosed at a level sufficient to provide 1×10⁷ cfu of starter culture/g of meat. The mixture of dextrose, meat slurry and starter culture was brought to a temperature between 104 and 110° F. and incubated between 8 and 14 hours. The incubated mixture resulted in a pH of about 4.6.

TABLE 2
Meat Slurry Composition

| Ingredient | Percent by Weight |
|---|---|
| Mechanically deboned chicken | To 100 |
| Dextrose | 2.0 |
| Starter Culture* | 0.0626 |

*Starter Culture contains sufficient Pediococcus acidilactici and Pediococcus pentosaceus to provide 1 × 10⁷ cfu/g of mechanically deboned chicken meat.

### Example 3

### Composition and Method of Making Chicken Meat Slurry Enriched with Starter Culture

In this Example, one embodiment of a cultured meat slurry as would occur in a typical slaughter house facility comprises mechanically deboned chicken mixed with apple juice concentrate and a rejuvenated starter culture.

The composition of the cultured meat slurry is set forth in Table 3. The mechanically deboned chicken was ground and emulsified to form a meat slurry. The apple juice concentrate was added into the meat slurry at 5.5% by weight of the total mixture. The starter culture, consisting essentially of Pediococcus acidilactici and Pediococcus pentosaceus (Bactoferm LHP, Chr. Hansen, Milwaukee, Wis.), was added to distilled water (42 g starter culture/100 g water) and the cultures were allowed to rejuvenate for 30 min at ambient (65 to 75° F.) temperature. The starter culture water mixture (142 g/500 pounds of meat) was then dosed at a level sufficient to provide 1×10⁷ cfu of starter culture/g of meat. Commercially available meat tenderizers were used to provide papain and bromelain as the proteolytic enzymes. The proteolytic enzymes were added to provide 2.5 grams of Adolph's® Tenderizer for meat and 2.5 grams of Kroger® meat tenderizer for each pound of meat. The mixture of apple juice concentrate, meat slurry, starter culture and proteolytic enzymes was brought to a temperature between 104 and 110° F. and incubated between 8 and 14 hours. The incubated mixture resulted in a pH of about 4.6.

TABLE 3
Meat Slurry Composition

| Ingredient | Percent by Weight |
|---|---|
| Mechanically deboned chicken | To 100 |
| Apple Juice Concentrate | 5.5 |
| Starter Culture* | 0.0626 |
| Proteolytic Enzymes** | 0.011 |

*Starter Culture contains sufficient Pediococcus acidilactici and Pediococcus pentosaceus to provide 1 × 10⁷ cfu/g of mechanically deboned chicken meat.
**Proteolytic enzymes include bromelain and papain provided by 2.5 grams of Adolph's ® Tenderizer for meat (papain) and 2.5 grams of Kroger ® meat tenderizer (bromelain) added to each pound of meat.

### Example 4

### Composition and Method of Making Beef Meat Slurry Enriched with Starter Culture

In this Example, one embodiment of a cultured meat slurry as would occur in a typical slaughter house facility comprises pieces of beef and mixing it with apple juice concentrate, proteolytic enzymes and a starter culture.

The composition of the cultured meat slurry is set forth in Table 4. The beef pieces were ground and emulsified to form a meat slurry. The starter culture, consisting essentially of Pediococcus acidilactici and Pediococcus pentosaceus (Bactoferm LHP, Chr. Hansen, Milwaukee, Wis.), was added to distilled water (42 g culture/100 g water) and the cultures were allowed to rejuvenate for 30 min at ambient (65 to 75° F.) temperature. The apple juice concentrate, the starter culture water mixture, and the proteolytic enzymes were then added into the meat slurry. The resultant dosing of starter culture was at a level sufficient to provide 1×10⁷ cfu of starter culture/g of meat while the proteolytic enzymes were dosed at 2.5 grams of Adolph's® Tenderizer for meat (bromelain) and 2.5 grams of Kroger® meat tenderizer (papain) for each pound of meat. The mixture of meat slurry and starter culture was brought to a temperature between 104 and 110° F. and incubated between 8 and 14 hours. The incubated mixture results in a pH of about 4.6.

TABLE 4
Meat Slurry Composition

| Ingredient | Percent by Weight |
|---|---|
| Beef pieces | To 100 |
| Apple Juice Concentrate | 5.5 |
| Starter Culture* | 0.0626 |
| Proteolytic Enzymes** | 0.011 |

*Starter Culture contains sufficient Pediococcus acidilactici and Pediococcus pentosaceus to provide 1 × 10⁷ cfu/g of mechanically deboned chicken meat.
**Proteolytic enzymes include bromelain and papain provided by 2.5 grams of Adolph's ® Tenderizer for meat (bromelain) and 2.5 grams of Kroger ® meat tenderizer (papain) added to each pound of meat.

### Example 5

### Extension of Shelf-Life Results

In this Example, one embodiment of a cultured meat slurry was made comprising ground up chicken and mixing it with apple juice concentrate and a starter culture.

The composition of the cultured meat slurry is set forth in Table 5. The chicken was ground and emulsified to form a meat slurry. The starter culture, consisting essentially of Pediococcus acidilactici and Pediococcus pentosaceus (Bactoferm LHP, Chr. Hansen, Milwaukee, Wis.), was added to distilled water (42 g culture/100 g water) and the cultures allowed to rejuvenate for 30 min at ambient (65 to 75° F.) temperature. Apple juice concentrate and the starter culture water mixture were then added into the meat slurry. The resultant dosing of starter culture was at a level sufficient to provide 1×10⁷ cfu starter culture/g of meat. The meat slurry containing the starter culture water mixture and apple juice concentrate was incubated at 100° F. for five days. The incubated meat slurry containing the starter culture water mixture and apple juice concentrate was then placed at 60° F. for another seven days. At the end of 12 days the cultured meat slurry did not have a bad aroma. As a result, this cultured meat slurry had a shelf-life for at least 12 days.

TABLE 5
Meat Slurry Composition

| Ingredient | Percent by Weight |
|---|---|
| Mechanically Deboned Chicken | To 100 |
| Apple Juice Concentrate | 5.5 |
| Starter Culture* | 0.0626 |

*Starter Culture contains sufficient Pediococcus acidilactici and Pediococcus pentosaceus to provide 1 × 10⁷ cfu/g of mechanically deboned chicken meat.

### Example 6

### Reduction of Pathogens in Beef

In this Example, one embodiment of a cultured meat slurry was made comprising beef coarse ground (pass ¼ inch piece size) and mixing it with apple juice concentrate and a starter culture.

The composition of the cultured meat slurry is set forth in Table 6. The beef was ground and emulsified to form a meat slurry. The starter culture, consisting essentially of Pediococcus acidilactici and Pediococcus pentosaceus (Bactoferm LHP, Chr. Hansen, Milwaukee, Wis.), was added to distilled water (42 g culture/100 g water) and the cultures allowed to rejuvenate for 30 min at ambient (65 to 75° F.) temperature. Apple juice concentrate and the starter culture water mixture were then added into the meat slurry. The resultant dosing of starter culture water mixture was at a level sufficient to provide 1×10⁷ cfu starter culture/g of meat. The meat slurry containing the starter culture was vacuum packaged and incubated at 110° F. for 12 hours. At every 2 hour interval, the bacterial count (CFU/g) and pH was assessed. Results as shown in FIG. 3 demonstrate that surrogate salmonella cultures die off starting at 4 hours until there were no viable salmonella surrogates at 12 hours. Since the starting level of salmonella surrogates was over 1×10⁶ cfu/g the culturing process reduced the pathogenic organisms by more than 6 logs. The pH of the mixture gradually declined throughout until 12 hours where pH is about 4.7. At the end of 12 hours the cultured meat slurry did not have a bad aroma.

TABLE 6
Meat Slurry Composition

| Ingredient | Percent by Weight |
|---|---|
| Ground up beef | To 100 |
| Apple Juice Concentrate | 5.5 |
| Starter Culture* | 0.0626 |

*Starter Culture contains sufficient Pediococcus acidilactici and Pediococcus pentosaceus to provide 1 × 10⁷ cfu/g of ground up beef.

### Example 7

### Maintaining Reduced Levels of Pathogens in Beef

In this Example, one embodiment of a cultured meat slurry had a shelf-life of ten months.

The cultured meat slurry of Example 6 was stored at conditions between 60 and 75° F. for four months. After four months the cultured meat slurry did not have a bad aroma and was at a pH of 4.55. As a result, this incubated mixture of meat slurry, starter culture and apple juice concentrate demonstrated a shelf-life of at least ten months.

### Example 8

### Reduction of Pathogens in Pork

In this Example, one embodiment of a cultured meat slurry was made comprising pork coarse ground (¼ inch piece size) and mixing it with apple juice concentrate and a starter culture.

The composition of the cultured meat slurry is set forth in Table 7. The pork was ground and emulsified to form a meat slurry. The starter culture, consisting essentially of Pediococcus acidilactici and Pediococcus pentosaceus (Bactoferm LHP, Chr. Hansen, Milwaukee, Wis.), was added to distilled water (42 g culture/100 g water) and the cultures allowed to rejuvenate for 30 min at ambient (65 to 75° F.) temperature. The apple juice concentrate and the starter culture water mixture were then added into the meat slurry. The resultant dosing of starter culture was at a level sufficient to provide 1×10⁷ cfu starter culture/g of meat. The meat slurry containing the apple juice concentrate and starter culture water mixture was vacuum packaged and incubated at 110° F. for 12 hours. At every 2 hour interval, the bacterial count (CFU/g) and pH was assessed. Results as shown in FIG. 4 demonstrate the active growth of the bacterial culture until about 4 hours after which bacterial viability rapidly declined until being nearly 1×10³ CFU/g at 12 hours. Since the highest level of salmonella surrogates was over 1×10⁷ cfu/g the culturing process reduced the pathogenic organisms by more than 4 logs. The pH of the mixture rapidly declines until 8 hours and then gradually declined until 12 hours where pH is about 4.0. At the end of 12 hours the cultured meat slurry did not have a bad aroma.

TABLE 7
Meat Slurry Composition

| Ingredient | Percent by Weight |
|---|---|
| Ground up pork | To 100 |
| Apple Juice Concentrate | 5.5 |
| Starter Culture* | 0.0626 |

*Starter Culture contains sufficient Pediococcus acidilactici and Pediococcus pentosaceus to provide 1 × 10⁷ cfu/g of ground pork meat.

### Example 9

### Maintaining Reduced Levels of Pathogens in Pork

In this Example, one embodiment of a cultured meat slurry had a shelf-life of four months.

The cultured meat slurry of Example 8 was stored at conditions between 60 and 75° F. for four months. After four months the cultured meat slurry did not have a bad aroma and was at a pH of 4.55. As a result, this incubated mixture of meat slurry, apple juice concentrate, and starter culture demonstrated a shelf-life of at least four months.

### Example 10

### Maintaining Reduced Levels of Spoilage Organisms in Chicken

In this Example, one embodiment of a cultured meat slurry made from mechanically de-boned chicken had a shelf-life of 18 days.

The composition of the cultured meat slurry is set forth in Table 8. The chicken was ground to form a meat slurry. The starter culture, consisting essentially of Pediococcus acidilactici and Pediococcus pentosaceus (Bactoferm LHP, Chr. Hansen, Milwaukee, Wis.), was added to distilled water (42 g culture/100 g water) and the cultures allowed to rejuvenate for 30 min at ambient (65 to 75° F.) temperature. The apple juice concentrate, proteolytic enzymes from Kroger® Meat Tenderizer (a source of bromelain) and Adolph's® Meat Tenderizer (a source of papain), and the starter culture water mixture were then added into the meat slurry. The resultant dosing of starter culture was at a level sufficient to provide 1×10⁷ cfu starter culture/g of meat. The product was packaged for culturing into plastic tubs and covered with plastic lids. The meat slurry containing the apple juice concentrate, enzymes and starter culture water mixture was incubated at 100° F. for 12 hours. The incubated meat slurry culture was then stored at 100° F. for 5 days and at 60° F. for an additional 13 days. After 18 days the cultured meat slurry did not have a bad aroma and was at a pH of 4.7. As a result, this incubated mixture demonstrated a shelf-life of at least 18 days.

TABLE 8
Meat Slurry Composition

| Ingredient | Percent by Weight |
|---|---|
| Mechanically de-boned chicken | To 100 |
| Apple Juice Concentrate | 5.5 |
| Starter Culture* | 0.0626 |
| Proteolytic enzymes** | 0.02 |

*Starter Culture contains sufficient Pediococcus acidilactici and Pediococcus pentosaceus to provide 1 × 10⁷ cfu/g of mechanically de-boned chicken.
**Proteolytic enzymes include bromelain and papain provided by 4.5 grams of Adolph's ® Tenderizer for meat (bromelain) and 4.5 grams of Kroger ® meat tenderizer (papain) added to each pound of meat.

### Example 11

### Maintaining Reduced Levels of Spoilage Organisms in Chicken

In this Example, one embodiment of a cultured meat slurry made from a blend of mechanically de-boned chicken and whole chicken meat had a shelf-life of 21 days.

The composition of the cultured meat slurry is set forth in Table 9. Equal parts by weight of mechanically de-boned chicken and whole chicken meat were ground to form a meat slurry. The starter culture, consisting essentially of Pediococcus acidilactici and Pediococcus pentosaceus (Bactoferm LHP, Chr. Hansen, Milwaukee, Wis.), was resuscitated in distilled water (42 g culture/100 g water) and the cultures allowed to rejuvenate for 30 min at ambient (65 to 75° F.) temperature. Dextrose and the starter culture water mixture were then added into the meat slurry either with a source of papain and bromelain or without a source of papain and bromelain. The resultant dosing of resuscitated starter culture water mixture (142 g/500 pounds of beef) was added at a level sufficient to provide 1×10⁷ cfu/g of meat. The products were packaged for culturing into plastic tubs and covered with plastic lids. The meat slurries containing the dextrose, a starter culture water mixture and either with a source of papain and bromelain or without a source of papain and bromelain were incubated at 100° F. for 8 hours. The cultured meat slurries were then stored at 45° F. for an additional 21 days. After 21 days the aroma of both the cultured meat slurry with an added source of papain and bromelain and the cultured meat slurry without an added source of papain and bromelain were evaluated. Both of the cultured meat slurries did not have a bad aroma and both were at a pH of <4.7. As a result, both incubated mixtures demonstrated a shelf-life of at least 21 days.

TABLE 9
Meat Slurry Composition

| Ingredient | Percent by Weight |
|---|---|
| Mechanically de-boned chicken and | To 100 |
| Whole Chicken Meat | |
| Dextrose | 2.0 |
| Starter Culture* | 0.0626 |
| Proteolytic enzymes (if added)** | 0.02 |

*Starter Culture contains sufficient Pediococcus acidilactici and Pediococcus pentosaceus to provide 1 × 10⁷ cfu/g of mechanically de-boned chicken.
**Proteolytic enzymes include bromelain and papain provided by 4.5 grams of Adolph's ® Tenderizer for meat (bromelain) and 4.5 grams of Kroger ® meat tenderizer (papain) added to each pound of meat.

All documents cited in the Detailed Description of the Disclosure are, in relevant part, incorporated herein by reference; the citation of any document is not to be construed as an admission that it is prior art with respect to the present disclosure. To the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the invention. It is therefore intended to cover in the appended claims all such changes and modifications that are within the scope of this invention

1. A composition for use in a pet food, the composition comprising: a meat slurry, a starter culture and a culture energy source.

2. The composition of claim 1 wherein the composition is included in one or more of the following: an extruded pet food, a retorted pet food, a baked pet food.

3. The composition of claim 1 wherein the meat source originated from a slaughter house and was labeled as for pet food use only.

4. The composition of claim 1 wherein the meat is selected from one or more of the following: chicken, turkey, beef, pork, buffalo, venison and lamb.

5. The composition of claim 1 wherein the starter culture is selected from one or more of the following: Pediococcus acidilactici, Pediococcus pentosaceus, Lactococcus lactic, Lactococcus cremoris, Lactobacillus delbruckii var bulgaricus, Lactobacillus plantarum, Lactobacillus pentosum, Streptococcus thermophilus, Lactobacillus sakei, and Lactobacillus curvatus.

6. The composition of claim 5 wherein the starter culture has been preserved with a cryoprotectant

7. The composition of claim 6 wherein the cryoprotectant is selected from one or more of the following: glycerol, dimethyl sulfoxide, DMSO, propylene glycol, and sucrose.

8. The composition of claim 1 wherein the culture energy source is selected from one or more of the following: apple juice, apple juice concentrate, dextrose, dextrose monohydrate, dextrose hydride, grape sugar, D-glucose, corn sugar, corn syrup solids, high fructose corn syrup, levulose, glucose, fructose, galactose, xylose, ribose, mannose, sorbose, high fructose corn syrup, apple pulp, honey, sugar, maple syrup, pear juice, grape juice, orange juice, and fruit juice

9. The composition of claim 1 wherein the composition has a shelf-life of at least ten days.

10. A composition for use in a pet food, the composition comprising: chicken meat, Pediococcus acidilactici, Pediococcus pentosaceus, and dextrose wherein the composition has a shelf-life of at least ten days.

11. The composition of claim 10 wherein the composition has a shelf-life of at least 14 days.

12. The composition of claim 10 wherein the composition has a shelf-life of at least four months.

13. The composition of claim 10 wherein the composition has a shelf-life of at least ten months.

14. A method of extending the shelf-life of a meat used in pet foods, the method comprising: grinding the meat pieces into a meat slurry, adding a culture energy source, inoculating the meat slurry with a starter culture, heating the meat slurry to make a meat slurry culture, and incubating the meat slurry culture.

15. (canceled)

16. The composition of claim 14 wherein the meat source originated from a slaughter house and was labeled as for pet food use only.

17. (canceled)

18. (canceled)

19. The composition of claim 14 wherein the starter culture is selected from one or more of the following: Pediococcus acidilactici, Pediococcus pentosaceus, Lactococcus lactis, Lactococcus cremoris, Lactobacillus delbruckii var bulgaricus, Lactobacillus plantarum, Lactobacillus pentosum, Streptococcus thermophilus, Lactobacillus sakei, and Lactobacillus curvatus.

20. The composition of claim 14 wherein the starter culture has been revitalized by adding it to water for at least 15 min.

21.-23. (canceled)

24. The composition of claim 14 wherein the culture energy source is selected from one or more of the following: apple juice, apple juice concentrate, dextrose, dextrose monohydrate, dextrose hydride, grape sugar, D-glucose, corn sugar, corn syrup solids, high fructose corn syrup, levulose, glucose, fructose, galactose, xylose, ribose, mannose, sorbose, high fructose corn syrup, apple pulp, honey, sugar, maple syrup, pear juice, grape juice, orange juice, and fruit juice.

25. The composition of claim 14 wherein the meat slurry culture has been incubated at 100 to 110° F. for at least four hours.

26.-27. (canceled)

28. The composition of claim 14 wherein the meat slurry culture has the added step of being incubated for at least one additional hour at 120 to 130° F.

29. (canceled)

30. The composition of claim 14 wherein the meat slurry is inoculated with proteolytic enzymes.

31. The composition of claim 14 wherein the shelf life is at least 10 days.

32. The composition of claim 14 wherein the shelf life is at least 14 days.

33. The composition of claim 14 wherein the shelf life is at least 4 months.

34.-60. (canceled)
